(19) United States
(12) Patent Application Publication
(10) Pub. No.: US 2010/0154306 A1
(43) Pub. Date: Jun. 24, 2010

(54) CUSTOMIZABLE DOOR HANGER AND PEEPHOLE

(76) Inventor: Clarence Driggers, Deltona, FL (US)

Correspondence Address: Daniel Law Offices, 37 N. Orange Ave., Suite 500, Orlando, FL, 32801, US

(21) Appl. No.: 12/639,930

(22) Filed: Dec. 16, 2009

Related U.S. Application Data
(60) Provisional application No. 61/139,450, filed on Dec. 19, 2008.

(51) Int. Cl. E06B 7/30; G09F 3/00; G02B 25/04; B23P 11/00

(52) U.S. Cl. 49/70; 40/299.01; 359/504; 29/428

(57) ABSTRACT

A customizable door hanger and peephole can include a main body having a top portion and a lower portion, a peephole and a hook for securing decorations. The peephole can be attached through a door opening and a decorative cover can be configured to attach the main body.

### CROSS-REFERENCE TO RELATED APPLICATIONS

This application claims the benefit of U.S. provisional Patent Application No. 61/139,450 filed on Dec. 19, 2008, the entire contents of which are hereby incorporated by reference.

### FIELD OF THE INVENTION

The present invention relates generally to a customizable exterior door hanger and an integrated peep hole.

### BACKGROUND OF THE INVENTION

One of the benefits of home ownership is the ability to make the appearance of the home match the likes and interests of the home owner. One common way to accomplish this is by decorating the front door of the home. This is typically accomplished by drilling or nailing a conventional square-type hook into the door and suspending a decoration from the hook. When this occurs, the placement of the decoration often obstructs an existing peephole or prevents placement of a new peephole. As such, a homeowner is often unable to identify visitors to the home without exposing the owner to danger by opening the door. Moreover, as the hook is affixed with screws or nails, damage occurs to the door and prevents the owner from removing the hook without exposing the damage. Additionally, as the decorations tend to be seasonal in nature, the homeowner is often left with a bare hook attached to the front door which is unappealing and fails to show the interests of the homeowner.

### SUMMARY OF THE INVENTION

The present invention is directed to a customizable door hanger and peephole. One embodiment of the present invention can include a main body having a top portion and a lower portion, and a hook for securing decorations. The embodiment may further include a peephole configured to attach the main body to a door through an opening.

Another embodiment of the present invention can include a method of manufacturing a customizable door hanger and peephole as described above.

Yet another embodiment of the present invention can include a door comprising a customizable door hanger and peephole as described above.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a front view of a customizable door hanger and peephole according to one embodiment of the present invention.

FIG. 2 is a side view of the customizable door hanger and peephole of FIG. 1.

FIG. 3 is a side view of the customizable door hanger and peephole in accordance with an alternate embodiment of the present invention.

FIG. 4 is a side view of the customizable door hanger and peephole in accordance with an alternate embodiment of the present invention.

FIG. 5 is a front view of a customizable door hanger and peephole according to an alternate embodiment of the present invention.

FIG. 6 is a front view of a customizable door hanger and peephole according to an alternate embodiment of the present invention.

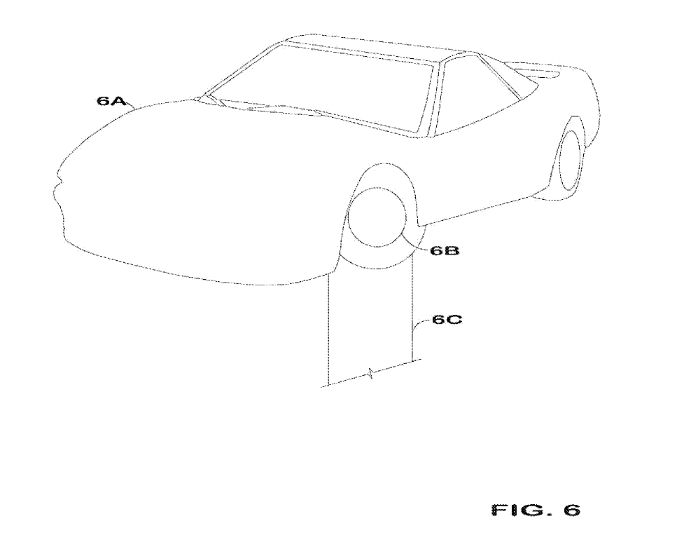

FIG. 7 is a front view of a customizable door hanger and peephole according to an alternate embodiment of the present invention.

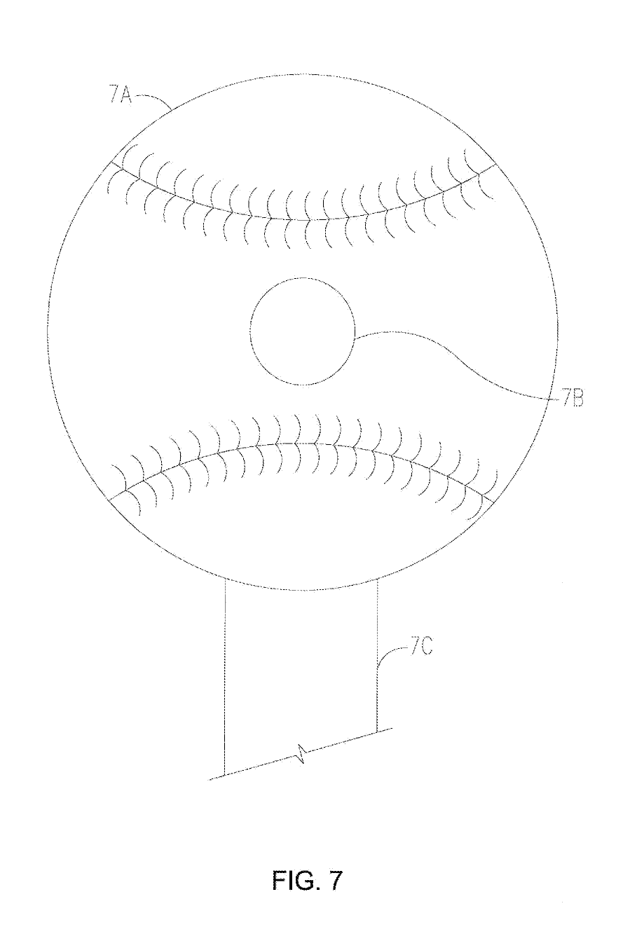

FIG. 8 is a front view of a customizable door hanger and peephole according to an alternate embodiment of the present invention.

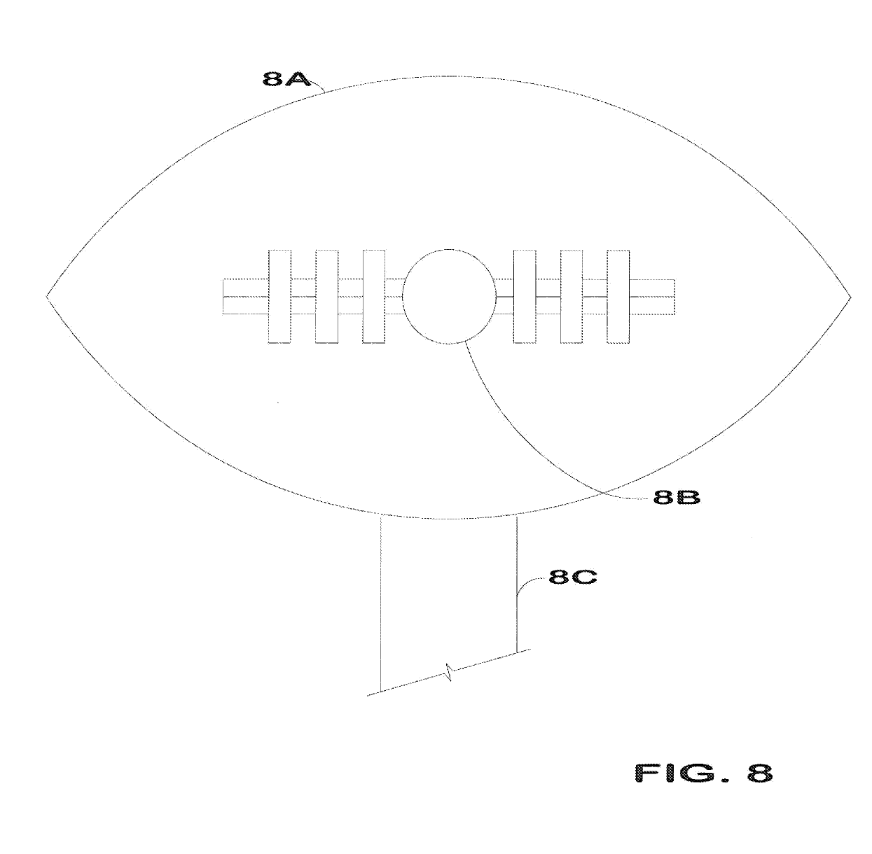

FIG. 9 is a front view of a customizable door hanger and peephole according to an alternate embodiment of the present invention.

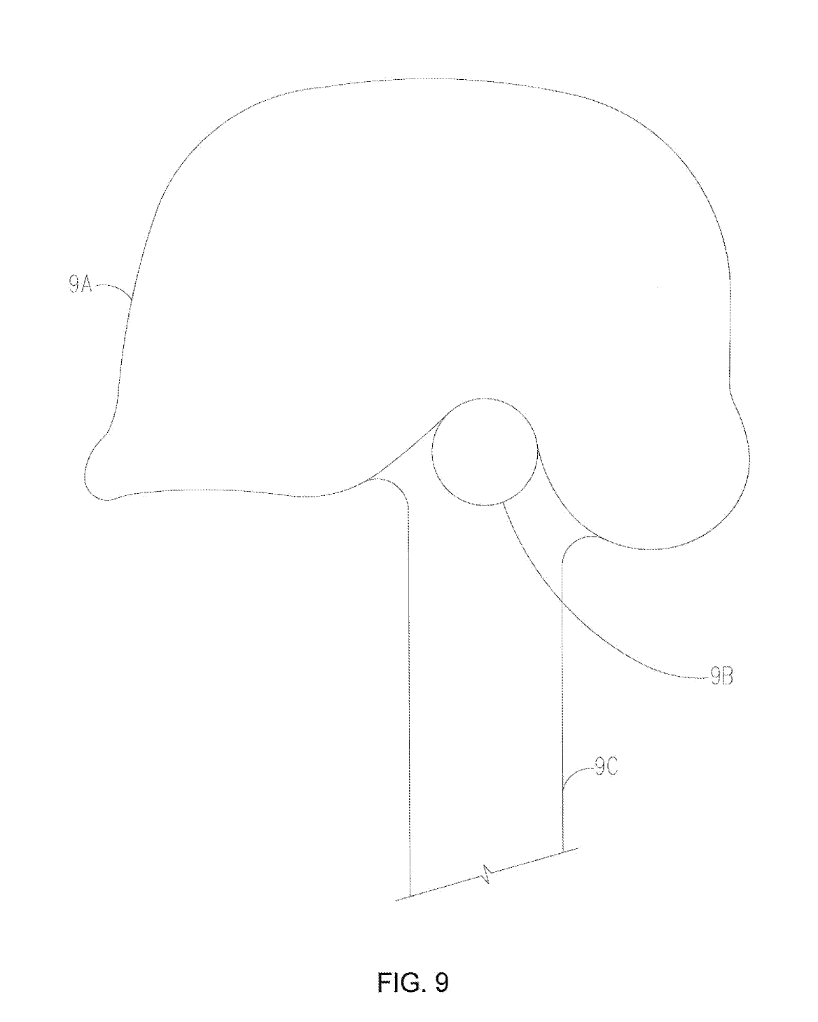

FIG. 10 is a flow chart illustrating a method for attaching a customizable door hanger and peephole to an existing door.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

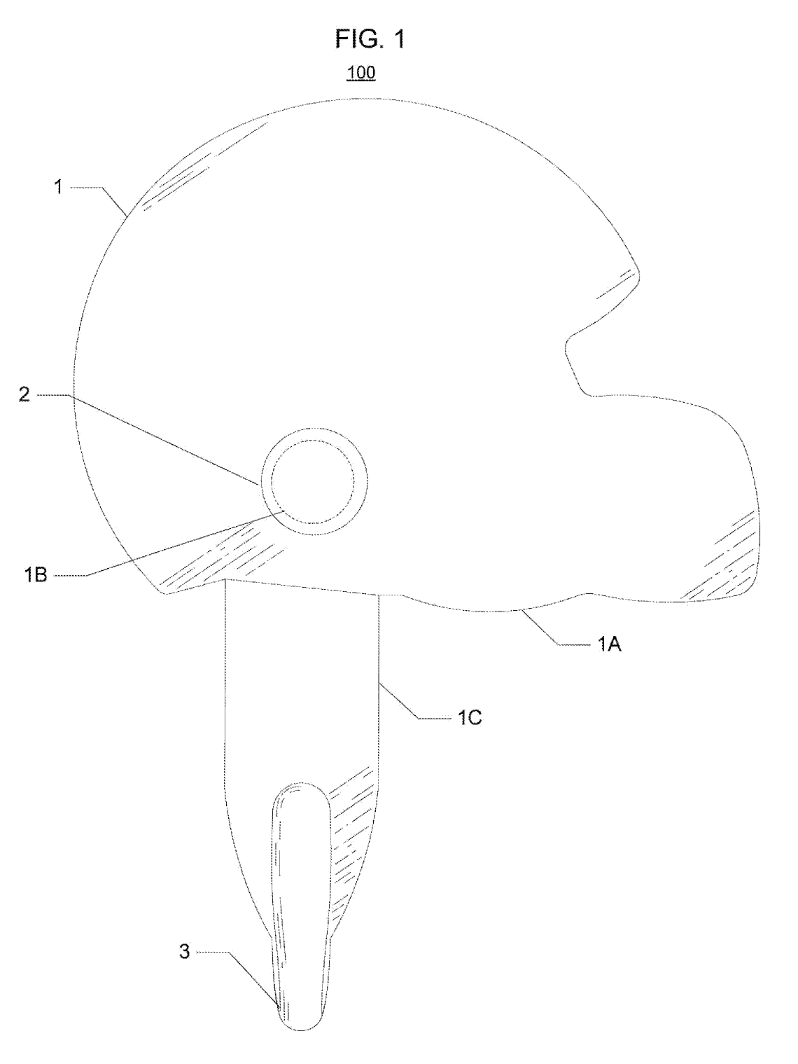

Referring to FIG. 1, a customizable door hanger and peephole 100 according to one embodiment includes a housing 1, a peephole 2 and a hook 3.

The housing 1 acts as a base to which the hook and the peep hole can be mounted. As shown in FIG. 1, the housing can include a large upper portion 1A with an opening 1B through which a portion of the peep hole 2 can be inserted. The housing can also include an elongated lower portion 1C to which the hook 3 can be attached.

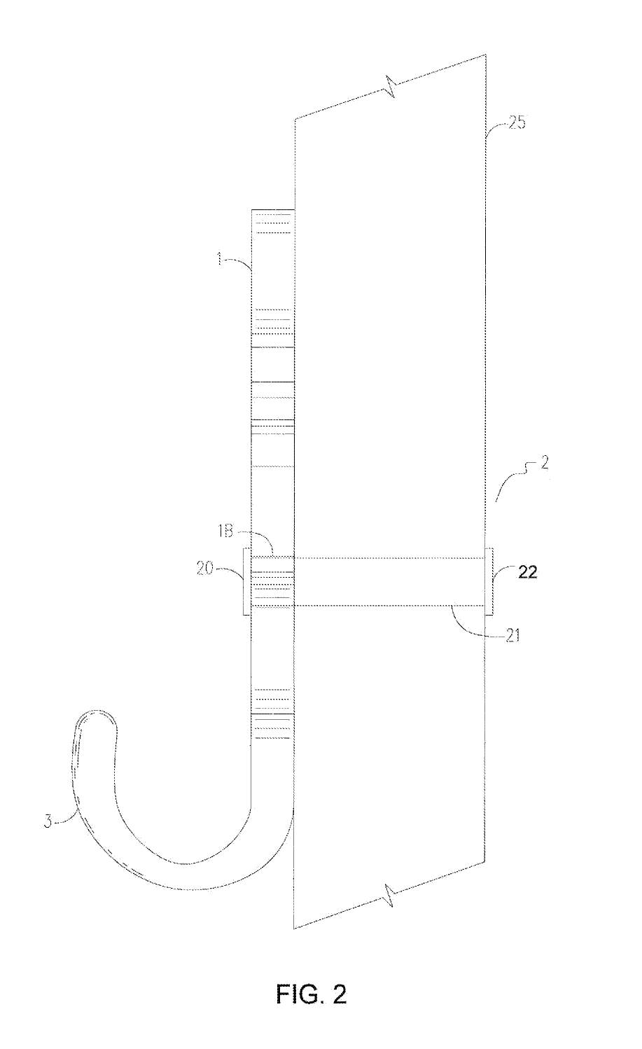

In one embodiment, the upper portion of the housing 1A (upper housing) can take the shape of a football helmet and the opening 1B can be located near the bottom center of the housing 1A. By placing the peephole 2 in this location, the peephole can look like it is merely the earpiece of the helmet which will thus allow the peephole to be unnoticed by a visitor (See FIG. 2). Such a feature is desirable for added security to the homeowner who may not want a visitor to know that they are being watched. Additionally, depending on the contour of the peephole, the upper housing 1A can include a flat or convex surface in order to give a three dimensional appearance.

The lower portion of the housing 1B (lower housing) can extend downward from the upper housing 1A and include a hook 3 or other securing means on the end opposite the upper housing.

In a preferred embodiment, the upper housing can have a length and width ranging between three (3) to twelve (12) inches, and a thickness ranging between one quarter (¼) of an inch to two (2) inches. Likewise, the lower housing 1B can have a length ranging between three (3) to twelve (12) inches, a width ranging between one-half (½) and four (4) inches and a thickness ranging between one quarter of an inch to 2 inches. The housing 1 can be made from virtually any sturdy material suitable for the intended purpose including but not limited to: plastic, foam, metal, wood composite or other similar materials. As would be understood to one of skill in the art, the above dimensions merely illustrate a preferred embodiment and are not limiting upon the invention.

FIG. 2 illustrates a side view of the customizable door hanger and peephole of FIG. 1. As stated above, the peephole 2 can be removably positioned through the hole 1B. Once installed, the peephole can act to secure the apparatus 100 to a door. As illustrated in FIG. 2, the peephole 2 can include a faceplate 20 positioned securely against the upper housing 1A and a viewer 22 positioned on the inside portion of a door 25. The faceplate 20 and the viewer 22 can be connected via a peephole shaft 21 extending through the housing 1 and the door 25. Once positioned through the peephole opening of the door, the peephole 2 can secure the apparatus 100 to the door without the need for additional support such as nails or screws. As used herein, the peephole can be virtually any known apparatus for securely looking through a wall or door such as the device illustrated in U.S. Pat. No. 5,078,470.

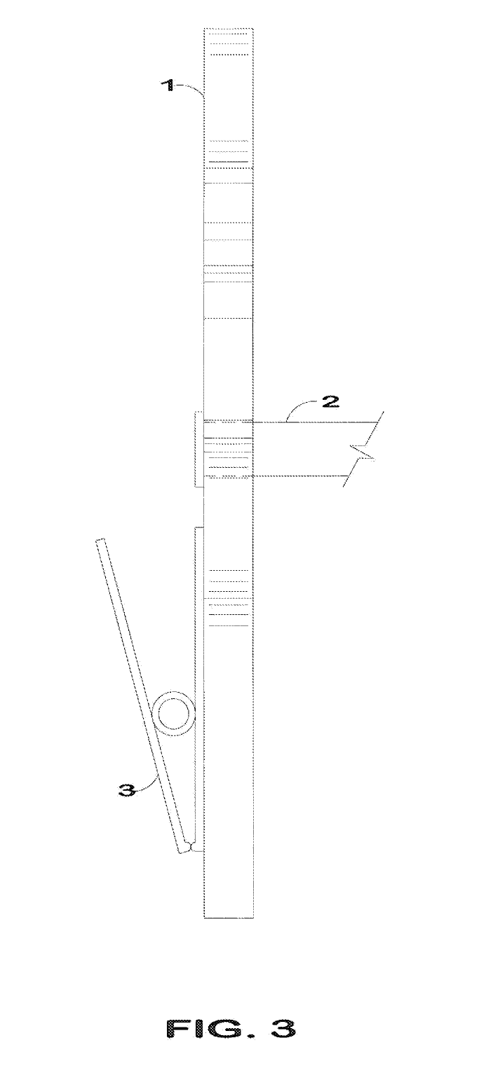

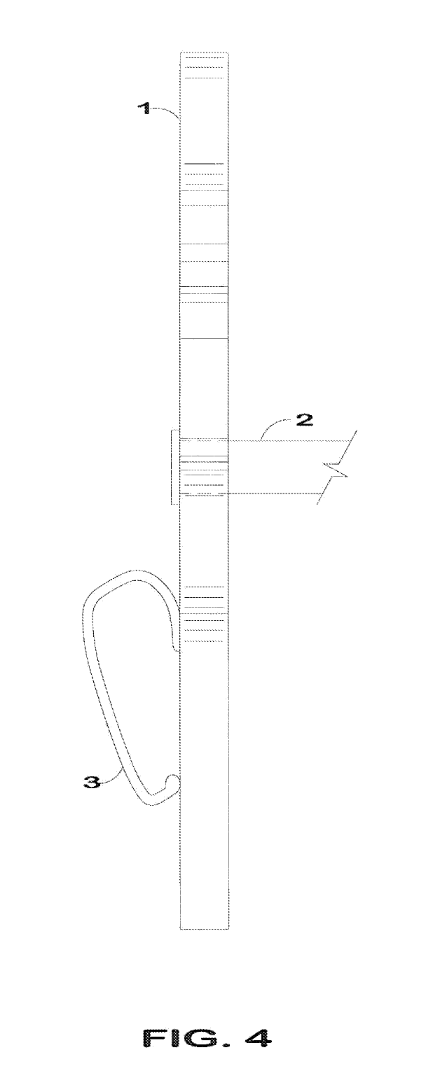

The hook 3 can be a single element molded into the lower housing 1C as illustrated above or may take any shape commonly employed for hanging items from a door. For instance, FIGS. 3 and 4 illustrate alternate embodiments of a hook 3 which may be included in the apparatus including a spring hook as illustrated in FIG. 3 or clip hook as illustrated in FIG. 4.

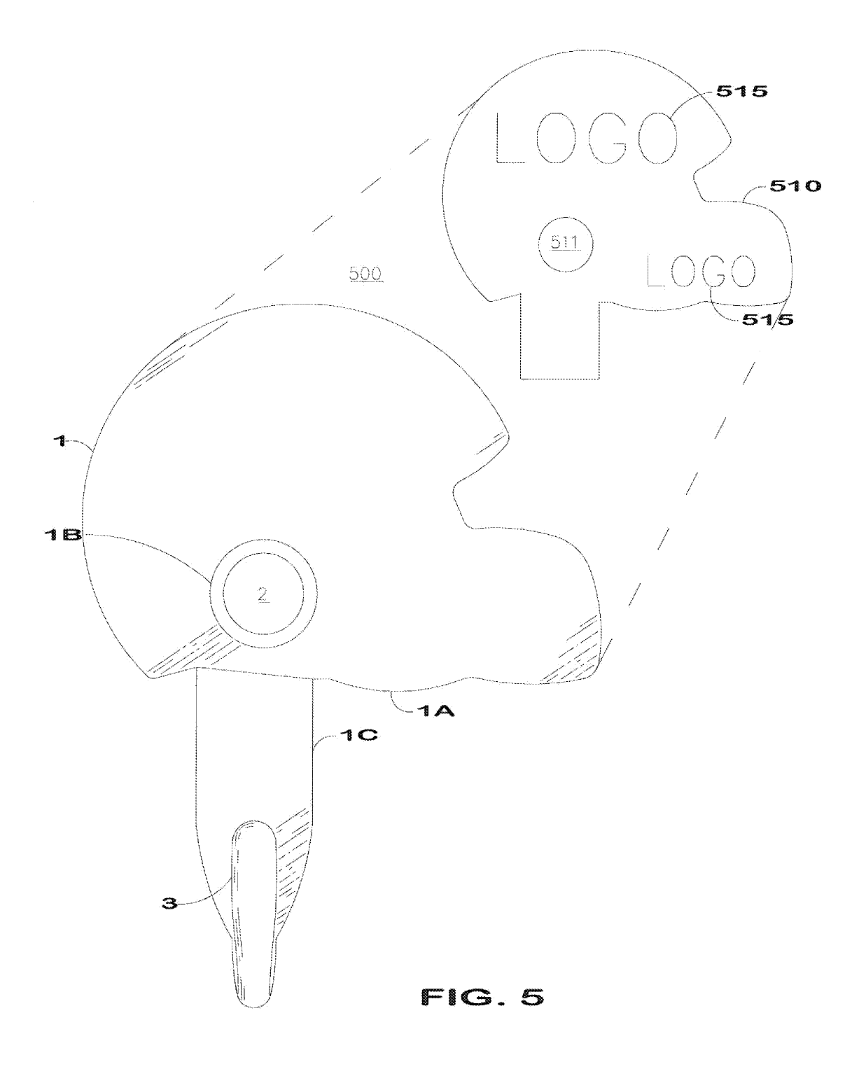

FIG. 5 illustrates a customizable door hanger and peephole 500 according to an alternate embodiment. As illustrated in FIG. 5, a customizable door hanger 500 such as that illustrated in FIGS. 1 and 2 can further include a cover 510. As shown, the cover 510 may be designed to attach to the surface area of the upper portion, the lower portion or a combination of the upper and lower portions of the housing 1A and can also include a hole 511 which can be aligned to coincide with the hole 1B of the housing 1. The cover 510 can preferably be made of a waterproof adhesive material such as plastic, vinyl or other malleable adhesive backed material. Alternatively, the cover 510 may be affixed to the housing 1 by other known means such as Velcro, magnets or removable adhesive, for example. In a further embodiment, the cover 510 can also include decorative markings 515. These markings can take virtually any shape including but not limited to: sports logos, custom messages, holiday greetings and the like. The incorporation of a cover 510, as described above, can act to further hide the faceplate of the peephole 20 and prolong the life of the device by offering protection from the elements. Although the customizable door hanger and peephole is described above with reference to an upper housing 1A having football helmet design, the invention is not so limited. For instance, one of skill in the art would recognize that the upper portion 1A can take a variety of shapes to suit an owners interests. These shapes can include, but are not limited to a car as illustrated in 6A, a baseball as illustrated in 7A, a football as illustrated in 8A or a military style helmet as illustrated in 9A.

In operation, a customizable door hanger and peephole as described above can securely mount to a door without the use of damaging screws or nails. By incorporating a hook at the bottom of the device, items hung from the hook will not block the faceplate 20 (i.e. viewing portion) of the peephole thus providing additional visual security to a homeowner. Moreover, by including a cover, the apparatus itself can be customized to the likings of the homeowner thus eliminating the need for removal during seasons where the owner does not wish to hang decorations from the included hook.

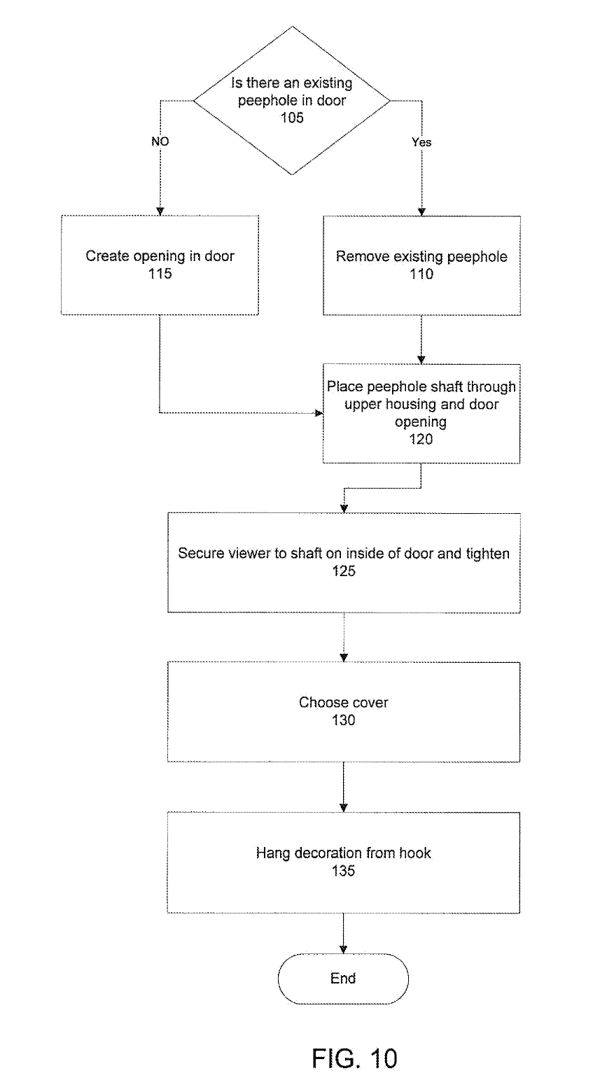

FIG. 10 illustrates a method for attaching a customizable door hanger and peephole to an existing door. The method begins at step 105, where a user determines if an existing peephole is installed in the door.

If a peephole is present, the user removes the peephole in step 110 and proceeds to step 120. If there is no existing peephole, the user must create a door opening in step 115 and then proceed to step 120.

In step 120, the shaft of the peephole is inserted through the upper housing and the door opening. In step 125, the faceplate is positioned securely against the upper housing and the viewer is securely attached to the shaft at the inside of the door opening.

In step 130, a user can install the optional cover and hang a decoration from the hook in step 135.

Although described above with reference to an existing door, the invention can be included within the manufacture of a new door and thus produced as a single unit.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A customizable door hanger and peephole comprising:
a main body having a top portion and a lower portion, said top portion having a predetermined shape;
a peephole; and
means for securing decorations, said means being disposed at a bottom end of said lower portion,
wherein said top portion further includes an opening through which said peephole is removably positioned.

2. The customizable door hanger and peephole of claim 1, further comprising:
a cover configured to overlap said main body.

3. The customizable door hanger and peephole of claim 2, wherein said cover is waterproof.

4. The customizable door hanger and peephole of claim 3, wherein said cover further includes a decorative logo.

5. The customizable door hanger and peephole of claim 3, wherein said cover is removably attached.

6. The customizable door hanger and peephole of claim 1, wherein said peephole is hidden from a visitor.

7. The customizable door hanger and peephole of claim 1, wherein said predetermined shape includes one of a helmet, a sports ball, and an automobile.

8. The customizable door hanger and peephole of claim 7, wherein said predetermined shape includes a flat portion.

9. The customizable door hanger and peephole of claim 7, wherein said predetermined shape includes a convex portion.

10. A method of manufacturing a customizable door hanger and peephole comprising:
providing a main body having a top portion having a predetermined shape and a lower portion;
providing a peephole; and
providing a hook disposed at a bottom end of said lower portion,
wherein said top portion further includes an opening through which said peephole is removably positioned.

11. A door comprising:
a peephole;
an opening configured to encompass the peephole; and
a door hanger including
a main body having a top portion and a lower portion, and
a hook disposed at a bottom end of said lower portion,
wherein said top portion includes an opening through which said peephole is positioned, and
said top portion includes a predetermined shape.

12. The door of claim 1, further comprising:
a cover configured to overlap said main body.

13. The door of claim 12, wherein said cover is waterproof.

14. The door of claim 13, wherein said cover further includes a decorative logo.

15. The door of claim 13, wherein said cover is removably attached.

16. The door of claim 11, wherein said peephole is hidden from a visitor.

17. The door of claim 11, wherein said predetermined shape includes one of a helmet, a sports ball, and an automobile.

18. The door of claim 17, wherein said predetermined shape includes a flat portion.

19. The door of claim 17, wherein said predetermined shape includes a convex portion.
